(19) United States
(12) Patent Application Publication
(10) Pub. No.: US 2025/0084764 A1
(43) Pub. Date: Mar. 13, 2025

(54) Longwall Shearer Positioning Method, Pan for Panline, Longwall Shearer System

(71) Applicant: Caterpillar Inc., Peoria, IL (US)

(72) Inventors: Martin TEINER, Peoria, IL (US); Rene BILSING, Peoria, IL (US)

(73) Assignee: Caterpillar Inc., Peoria, IL (US)

(21) Appl. No.: 18/724,735

(22) PCT Filed: Dec. 8, 2022
(86) PCT No.: PCT/US2022/081133

§ 371 Date: Jun. 27, 2024

(30) Foreign Application Priority Data
Dec. 27, 2021 (GB) 2119046.7

(51) Int. Cl. E21C 35/06; G01C 15/00

(52) U.S. Cl. CPC E21C 35/06; G01C 15/00

(57) ABSTRACT

The present invention pertains to a method for determining a 3D position of a longwall shearer traveling on a panline along a longwall face of an underground coal mining panel, the method comprising the steps of retrieving sensor data indicative of an absolute shearer coordinate and a shearer orientation, retrieving additional sensor data indicative of a relative shearer coordinate; and calculating the 3D position and orientation of the longwall shearer based on the absolute coordinate, the shearer orientation, and the relative shearer coordinate (\vec{y}). The present invention also pertains to a pan for a panline and a longwall shearer system comprising a longwall shearer and at least one such pan.

### TECHNICAL FIELD

The present invention pertains to a method for determining a 3D position of a longwall shearer traveling on a panline along a longwall face of an underground coal mining panel. The present invention also pertains to a pan for a panline for use in such method. Further, the present invention also pertains to a longwall shearer system for use with such method, comprising a longwall shearer, at least one such pan, and one or more hydraulic roof support.

### TECHNOLOGICAL BACKGROUND

To extract material along a longwall face in an underground mine, longwall shearers with typically two cutting drums may be provided. As is known per se, the longwall shearer reciprocates on a panline along the longwall face to extract coal material with the two rotating cutting drums. Extracted coal material is dropped onto a face conveyor running aside the longwall face between face and shearer to transport the extracted coal material away for further processing.

Hydraulic roof supports prevent roof material from collapsing on the longwall shearer including the panline and are further used to push the panline in a face advance, or coal retreat, direction. This usually happens right after the shearer passed a given pan segment of a pan line, giving a snake-like movement of the longwall shearer in the face advance direction. Behind the hydraulic roof support, the mined coal panel collapses.

Identif\vec{y}ᵢ ng shearer position and orientation during operation is crucial for controlling, monitoring and post-processing the mining progress, especially when the aim is to obtain a so-called digital twin of the shearer during operation. However, position measurement possibilities underground and during operation of the longwall shearer are limited. Reasons are physical limitations due to dust, fog, vibrations, darkness, mountain pressure induced coal seam movements, but also statutory limitations, for example the prohibition of lasers during operation.

Current positioning systems oftentimes use Inertial Navigation Systems, INS, also called Inertial Measurement Systems, IMS, for identif\vec{y}ᵢ ng a shearer orientation relative to an absolute coordinate system in the form of angles. Further, encoders or odometers are used for identif\vec{y}ᵢ ng an absolute shearer coordinate, giving one distance of the shearer relative to a fixed location in the coal seam. The INS usually comprises gyroscopes or other acceleration-based sensors. The INS outputs and the encoder outputs are then integrated and combined to a current shearer position.

Due to the slow movements of the shearer and high vibrations, acceleration data for positioning are vastly inaccurate. The yaw angle, which is usually not represented in INS based orientation detection, suffers from substantial drift when determined using positioning technologies known from the state of the art. As a result, the obtained shearer positions, or shearer trajectories, are inaccurate.

The method for determining a 3D position of a longwall shearer traveling on a panline along a longwall face of an underground coal mining panel, the pan for a panline, and the longwall shearer system solve one or more problems set forth above.

### SUMMARY OF THE INVENTION

Starting from the prior art, it is an objective of the present disclosure to provide a simple, reliable, cost-effective 3D positioning of a longwall shearer moving along a panline in an underground mining panel.

This objective is solved by means of a method for determining a 3D position of a longwall shearer traveling on a panline along a longwall face of an underground coal mining panel with the features of claim 1, a pan for a panline with the features of claim 13, and a longwall shearer with the features of claim 15. Preferred embodiments are set forth in the present specification, the Figures as well as the dependent claims.

Accordingly, a method for determining a 3D position of a longwall shearer traveling on a panline along a longwall face of an underground coal mining panel is provided, comprising the steps of retrieving sensor data indicative of an absolute shearer coordinate and a shearer orientation, retrieving additional sensor data indicative of the relative shearer coordinate, and calculating the 3D position and orientation of the longwall sheerer based on the absolute coordinate, the shearer orientation, and the relative shearer coordinate.

Further, a pan for a panline is provided, configured to be carried out with the method.

In addition, a longwall shearer system is provided, comprising a longwall shearer, at least one such pan, one or more hydraulic roof supports, the longwall shearer being configured for use in the method according to the present disclosure, wherein the longwall shearer comprises a sensor device, configured to retrieve sensor data indicative of an absolute shearer coordinate and a shearer orientation, and configured to retrieve additional sensor data indicative of a relative shearer coordinate.

### BRIEF DESCRIPTION OF THE DRAWINGS

The present disclosure will be more readily appreciated by reference to the following detailed description when being considered in connection with the accompan\vec{y}ᵢ ng drawings in which:

FIG. 1 schematically illustrates a computer rendering of a longwall mining sheerer in combination with a panline in a perspective view;

FIG. 2 schematically illustrates the axes of rotation of a longwall mining sheerer alone in a perspective view;

FIG. 3 shows a longwall mining shearer system during operation in a coal panel of a coal seam;

FIG. 4 shows a method for determining a 3D position of a longwall shearer according to an embodiment;

FIG. 5 shows a method for determining a 3D position of a longwall shearer according to another development of the embodiment of FIG. 4;

FIG. 6 shows the principles of the method of FIG. 5;

FIG. 7 shows a method for determining a 3D position of a longwall shearer according to another development of the embodiment of FIG. 4;

FIG. 8 shows the principles of the method of FIG. 7;

FIG. 9 shows a method for determining a 3D position of a longwall shearer according to another embodiment;

FIG. 10 shows forces acting on a pan for a panline according to an embodiment;

FIG. 11 shows a predicted panline predicted by the prediction step according to an embodiment;

FIG. 12 shows the principles of panline estimation; and

FIG. 13 shows a diagram of a method for determining a 3D position of a longwall shearer according to a further embodiment.

### DETAILED DESCRIPTION OF PREFERRED EMBODIMENTS

In the following, the invention will be explained in more detail with reference to the accompan\vec{y}ᵢ ng figures. In the Figures, like elements are denoted by identical reference numerals and repeated description thereof may be omitted in order to avoid redundancies.

In the following disclosure, the present invention is explained exemplary based on two embodiments, which may be used separately or in combination with each other. The first embodiment utilizes to the so-called “shearer trajectory” approach, whereas the second embodiment utilizes the so-called “panline” approach, as it will be explained in more detail below. The shearer trajectory approach relies on digitally stored shearer profiles, which represent, in their broadest definition, data representing an individual slice of a longwall face cut out by the shearer. The panline approach relies on the hardware of the shearer and is based on the panline geometry and relative displacements of individual pans of the panline relative to one other. In both embodiments, the underlying principle is the same, namely combining absolute and relative coordinate measurements to one value representing the 3D shearer position.

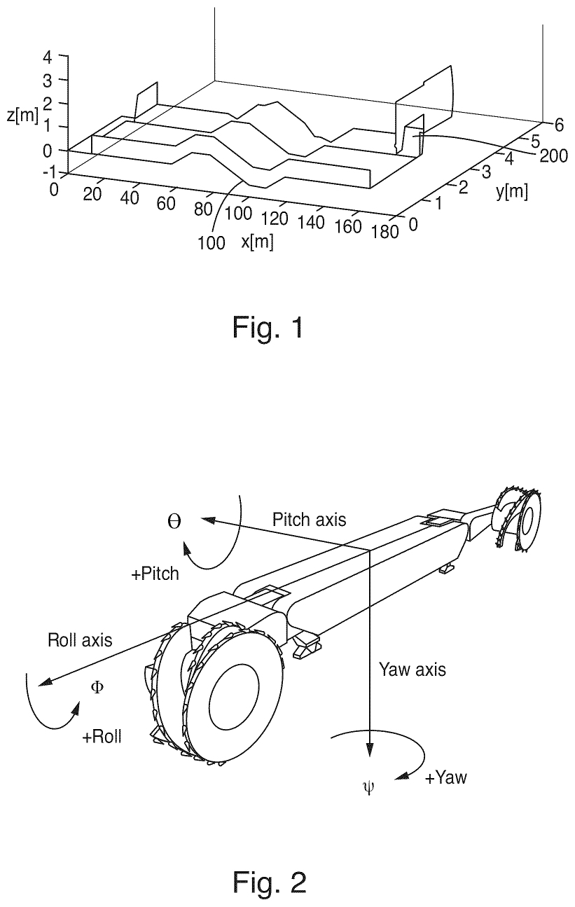

In FIG. 1, a computer rendering of a longwall mining sheerer in combination with a panline is shown in a perspective view. The longwall shearer 100 is configured to travel on a panline 200 along a longwall face of an underground mining panel (not shown in FIG. 1). The longwall shearer 100 reciprocates back and forth on the panline 200. Each movement occurs primarily in the x-direction according to the shown coordinate system. During each movement, from left to right, or from right to left, a slice of the longwall face is cut out of the coal mining panel. Each cut out slice may be stored by a profile, which may comprise data representing the slice. Behind the trailing end of the shearer 100, the panline 200 is moved forward incrementally into the face advance direction, also called coal retreat direction, which is represented by the y-coordinate. Thereby, the longwall shearer advances through the coal seam following a snake-like, or zigzag pattern.

To determine the 3D position of the shearer within the coal seam, current systems are based on Inertial Navigation Systems INS and an encoder or odometer. The INS provides angular displacements of the shearer relative to an absolute coordinate system. The encoder or odometer provides an absolute shearer coordinate based on a fixed reference point within the coal seam. As an example, at the end of a slice, a gate end may be provided, serving as fixed location in the coal seam for an encoder or odometer. Reaching the gate end, the shearer 100 may receive encoder data indicative of an absolute coordinate x of the shearer 100.

The underlying principle is to add a detected angular orientation change, for example in yaw, roll, and pitch angles, to a known absolute coordinate, thereby identif\vec{y}ᵢ ng the current position of the shearer in the coal seam. In general, travelled encoder distances are integrated with respect to the shearer orientation.

However, due to the slow movements of the shearer and high vibrations, the acceleration data of the Inertial Navigation System cannot be used for positioning. In particular, the yaw angle suffers from data drift, leading to inaccurate shearer trajectories.

FIG. 2 shows a longwall shearer 100 alone and illustrates the axes of rotation of the longwall sheerer 100 in a perspective view. The yaw axis, the z-axis of FIG. 1, representing the axis of rotation of the yaw angle ψ. The roll axis, the x-axis of FIG. 1, representing the axis of rotation of the roll angle Φ. The pitch axis, the y-axis of FIG. 1, representing the axis of rotation of the pitch angle ⊖.

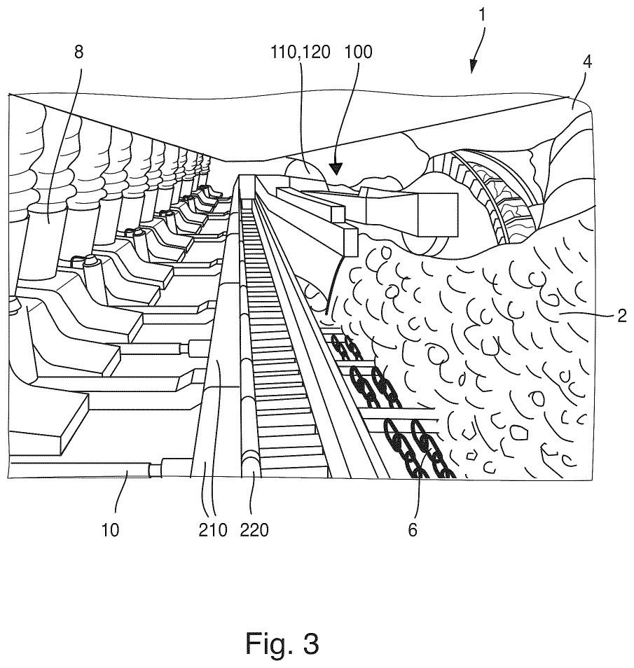

FIG. 3 shows a complete longwall mining shearer system during operation in a coal panel. A longwall shearer 100 is shown, traveling on a panline 200 along a longwall face 2 of an underground coal mining panel 4. The longwall shearer 100 cuts coal off the longwall face 2 and the cut coal falls on a conveyor belt 6. On the side of the longwall shearer 100 opposing the longwall face 2, hydraulic roof supports 8 are provided, comprising hydraulic cylinders 10 configured to push an individual pan 210 of the panline 200 in the face advance direction after the longwall shearer 100 has passed the individual pan 210.

The longwall shearer 100 may comprise several sensors. The longwall shearer 100 may comprise an Inertial Navigation System 110, providing a shearer orientation. For example, the Inertial Navigation System 110 may comprise a gyroscope. The longwall shearer 100 may comprise an encoder 120, providing an absolute shearer coordinate x. The panline 200 may comprise a panline measurement unit 220 as sensor device configured to measure gravity, relay bar forces, and/or pan collision forces. The hydraulic cylinders 10 may comprise a sensor device configured to provide additional sensor data indicative of a relative shearer coordinate \vec{y} in the face advance direction y.

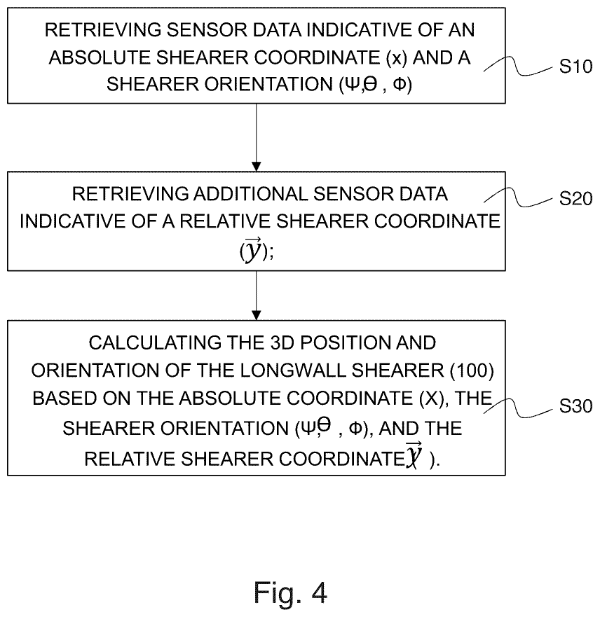

FIG. 4 illustrates a flow chart of a method according to a first embodiment of the present disclosure. The method is configured for determining a 3D position of a longwall shearer 100 travelling on a panline 200 along a longwall face 2 of an underground coal mining panel 4, the method comprising the steps of retrieving S10 sensor data indicative of an absolute shearer coordinate x and a shearer orientation ψ, ⊖, Φ, retrieving S20 additional sensor data indicative of a relative shearer coordinate f, and calculating S30 the 3D position and orientation of the longwall shearer 100 based on the absolute coordinate x, the shearer orientation ψ, ⊖, Φ, and the relative shearer coordinate \vec{y}. By including the additional sensor data indicative of a relative shearer coordinate, the algorithm can be improved to avoid the drift effect in the trajectory.

The absolute shearer coordinate x may for example comprise a value representing the shearer position 100 in x-direction from a fixed location in the coal seam. The shearer coordinate x may for example comprise multiple encoder position s k−1, k, k+1, wherein the additional sensor data indicative of a relative coordinate \vec{y} may comprise a retreat cylinder deflection \vec{y}ᵢ in the face advance direction y.

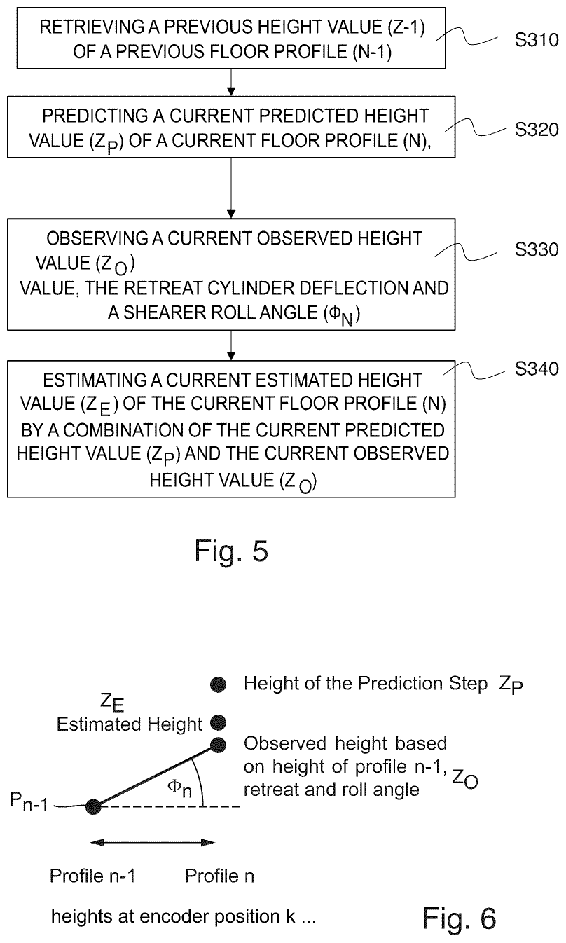

FIG. 5 illustrates a further development of the first embodiment. Accordingly, the calculation step S30 may comprise, for a given encoder position k, the steps of retrieving S310, a previous height value z−1 of a previous floor profile n−1, predicting S320, a current predicted height value z_{P} of a current floor profile n, observing S330, a current observed height value z_{O} based on the retrieved height value, the retreat cylinder deflection \vec{y}ᵢ, and a shearer roll angle Φ, and estimating S340 a current estimated height value z_{E} of the current floor profile n by a combination of the current predicted height value z_{P} and the current observed height value z_{O}.

The working principle of the development shown in FIG. 5 is illustrated in FIG. 6. The initial point Pₙ₋₁ may represent a shearer position calculated during a previous profile. This previous profile may be calculated by calculating one or more 3D positions and orientations of the longwall shearer 100 based on the absolute coordinate x, the shearer orientation ψ, ⊖, Φ, and the relative shearer coordinate \vec{y} according to the present disclosure.

Based on a previous profile n−1, the proposed method may determine an estimated height for the current profile n. This estimated height may be determined for a given x-coordinate, or encoder position k. According to a preferred embodiment, the method may be repeated for more or all encoder positions k.

The current observed height value z_{O} may be based on the current shearer roll angle Φₙ as detected by the Inertial Navigation System. The estimation step S340 may for example comprise an optimization algorithm, comprising a regression algorithm and/or a Kalman Filter.

The shown algorithm is an exemplary implementation for a Kalman Filter design only. This should not limit the invention as any other estimation or regression algorithm might replace the Kalman Filter.

The information may be fed into a Kalman Filter and used to estimate the position and the orientation of the shearer. The estimation of roll and pitch angle is a state of the art process in navigation Kalman Filters. The INS data and the encoder data might be used to calculate a trajectory in the prediction step of the Kalman Filter.

In the observation step, the encoder data, the retreat data and the shearer orientation are applied on the last profile data to determine further information on the shearer position. The information of prediction and observation may then be combined to provide the final position estimate as well as a yaw angle estimate.

In more detail, the prediction step might be implemented as standard integration algorithm for position and yaw angle orientation. The observation step is executed at specific encoder positions. If the observation step is executed, the shearer position of the last profile at the specific encoder position is used as reference for the position calculation. The retreat data and the roll angle of the shearer determine the slope and the distance from reference position to the actual position to be calculated.

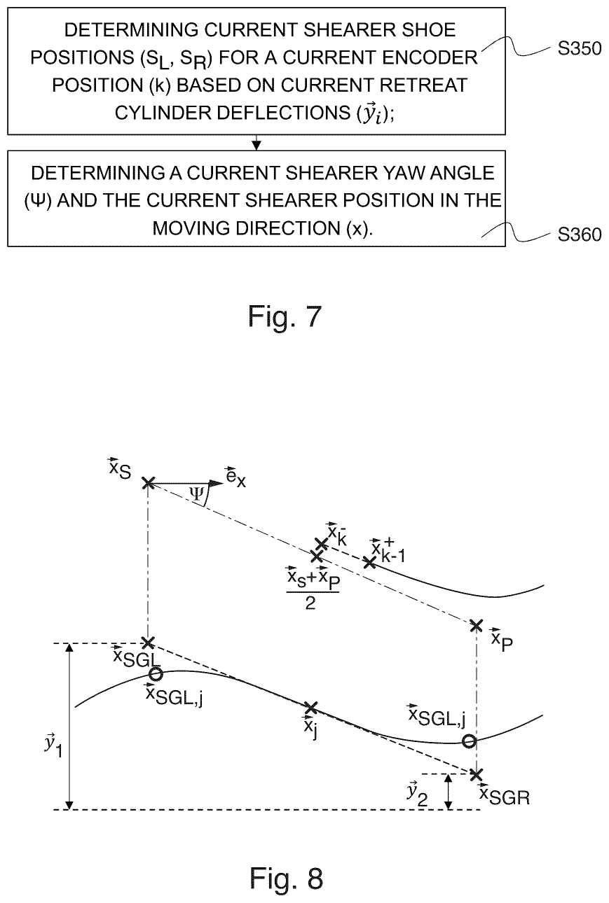

FIG. 7 illustrates a further development of the first embodiment. Accordingly, the method may further comprise the steps of determining S350, a current shearer shoe position S_{L}, S_{R} for a current encoder position k based on current retreat cylinder deflections \vec{y}ᵢ, and determining S360 a current shearer yaw angle ψ and the current shearer position in the moving direction x.

The shoe position may be a left shoe position S_{L} and/or a right shoe position S_{R}. Every time one pan 210 is displaced relative to another pan 210 in the face advance direction y, the shearer 100 is rotated about its yaw axis, thereby changing the yaw angle ψ. For each pan 210 of the panline 200, the relative pan displacement is known via the retreat cylinder deflection \vec{y}ᵢ in face advance direction y. Knowing the shearer geometry and shearer shoe geometry, a conclusion about the 3D position and orientation of the longwall shearer may be obtained. By this, the yaw angle ψ drift may be reduced substantially.

FIG. 8 illustrates the working principle of this development. Here, a shearer position xₖ may be calculated in an observation step. The corresponding observed shoe positions x_{SGL,j} and x_{SGR,j} are indicated by the two circles. The actual shoe positions x_{SGL} and x_{SGR} are different. Determining the current shoe positions x_{SGL} and x_{SGR} is possible via the current retreat cylinder deflections \vec{y}₁ and \vec{y}₂. Under consideration of the shearer geometry, in particular the shoe geometry, the current shearer yaw angle ψ and the current shearer position xₖ in the moving direction x may be determined.

In general, the calculation step S30 may comprise an optimization algorithm, comprising a regression algorithm and/or a Kalman Filter. In principle, relative coordinates y may be interpolated. In addition, the method may further comprise the step of generating S400 a shearer trajectory from at least two different outputs of the calculation step S30.

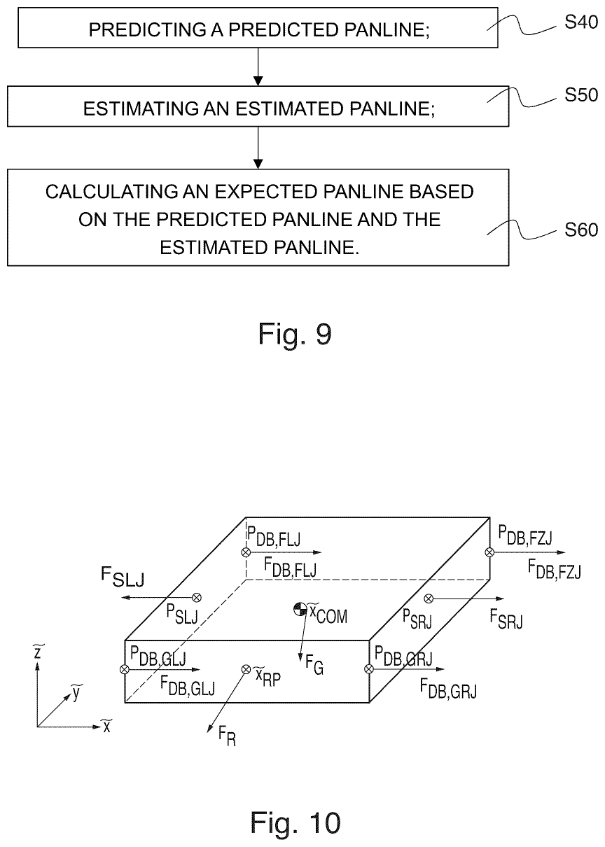

FIG. 9 schematically illustrates a flow diagram of a second embodiment of the method according to the present disclosure. Accordingly, the method for determining a 3D position of a longwall shearer 100 traveling on a panline 200 along a longwall face 2 of an underground coal mining panel 4, the method comprising the steps of retrieving S10 sensor data indicative of an absolute shearer coordinate x and a shearer orientation ψ, ⊖, Φ, retrieving S20 additional sensor data indicative of a relative shearer coordinate f, and calculating S30 the 3D position and orientation of the longwall shearer 100 based on the absolute coordinate x, the shearer orientation ψ, ⊖, Φ, and the relative shearer coordinate f. Further, the method according to the second embodiment further comprises the steps of predicting S40 a predicted panline, estimating S50 an estimated panline, and calculating S60 an expected panline based on the predicted panline and the estimated panline.

The panline prediction S40 may further comprise the steps of retrieving S42 a current panline, retrieving S44 retreat cylinder deflections \vec{y}ᵢ from the additional sensor data, and retrieving S46 a floor profile. Likewise, the panline estimation S50 may be established using the sensor data indicative of the absolute shearer coordinate x and the shearer orientation ψ, ⊖, Φ. Further, floor profile 300 data for positioning the panline 200 on the extracted floor may be required.

FIG. 10 shows forces acting on a pan body for the panline prediction step. In the panline prediction algorithm, each pan's position and orientation on the floor is predicted. The panline pose in the coal seam may be determined based on the last pan profile, the retreat information in face advance direction, the knowledge about the floor and the pan geometry. Pans may physically interact with each other. The pan's movements may therefore be restricted by dogbones, the floor and the displacement of the retreat cylinders in the roof supports (not shown in FIG. 10). All these interactions may lead to physical equations which may be used to calculate the position and orientation of each pan and finally the complete panline. Some forces representing the interactions and restrictions may be gravity, relay bar forces, and collision forces on the side planes. The set of physical equations and torques might be resolved by an optimization algorithm line Newton's method, but also ordinary differential equation solvers might be applied as an alternative.

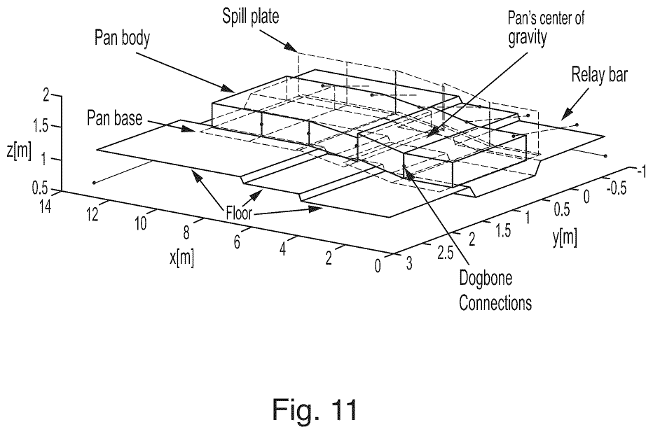

FIG. 11 shows predicted pans predicted by the prediction step. Shown is a panline comprising several pans with pan bodies having a center of gravity and a pan base facing the longwall face to be mined (not shown in FIG. 10). Accordingly, in the illustration shown in FIG. 10, the longwall face would run along the x-axis for a y-axis value of about 2.5. The shearer (not shown in FIG. 10) is configured to travel along the panline 200 which serves as a rail. The pan bodies may be connected via dogbone connections. Facing away from the longwall face to be mined, each pan may comprise a spill plate and a relay bar. The panline rests on the floor.

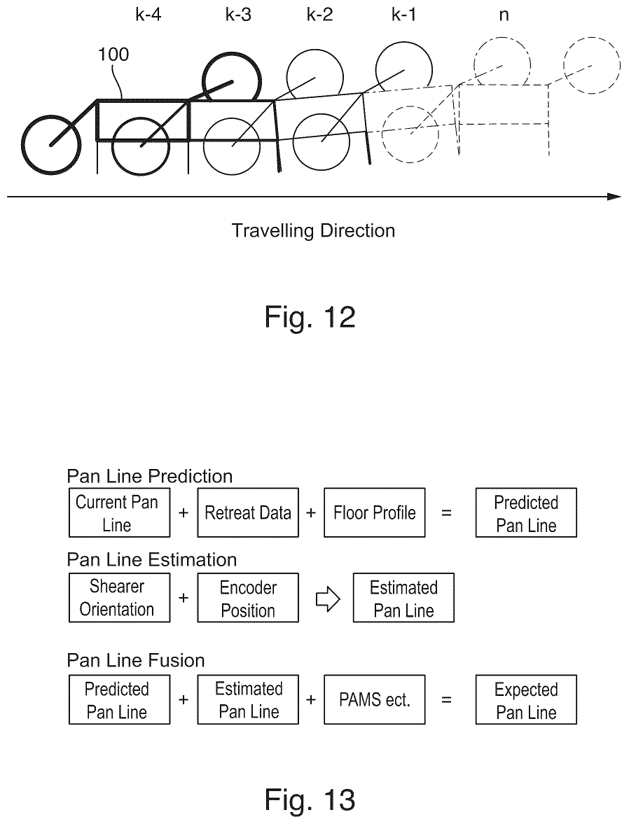

FIG. 12 shows the underlying principle of the panline estimation step. The panline estimation comprises using the sensor data indicative of an absolute shearer coordinate and a shearer orientation. In the panline estimation, it is assumed that shoe positions of the shearer match up as the shearer travels on the panline, which may be understood as a rail. However, the information between shoe positions is missing. To overcome this missing information, pan geometry information may be included.

The illustration of FIG. 12 represents a shearer 100 traveling on the panline 200 which is indicated by different encoder positions k−3, k−2, k−1, and k. From this information, it may be derived that the rear shoe of the shearer according to a later encoder position must have passed the position of a front shoe of the shearer according to an earlier encoder position. Therefore, retrieving an information of a front or rear shearer shoe passing the pan allows a conclusion on which pan, or in which pan intersection the shearer is currently positioned. To this end, it is required to know the shearer shoe geometry as a function of the encoder position.

FIG. 13 shows a diagram of a method for determining a 3D position of a longwall shearer according to a further embodiment. Accordingly, the panline prediction step may cover the steps of retrieving a current pan line, retreat data, and a floor profile which results in a predicted panline. The panline estimation step may cover retrieving the shearer orientation and retrieving the encoder position which results in an estimated panline. Finally, in a panline fusion step, the predicted panline and the estimated panline as well as data taken from the pan measurement unit are retrieved which results in an expected panline.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

This is in particular the case with respect to the following optional features which may be combined with some or all embodiments, items and all features mentioned before in any technically feasible combination.

A method for determining a 3D position of a longwall sheerer traveling on a panline along a longwall face of an underground coal mining panel may be provided, the method comprising the steps of retrieving sensor data indicative of an absolute shearer coordinate and a shearer orientation, retrieving additional sensor data indicative of a relative shearer coordinates, and calculating the 3D position and orientation of the longwall sheerer based on the absolute coordinate, the shearer orientation, in the relative shearer coordinate.

In the sense of the present disclosure, and absolute shearer coordinate may be a coordinate running from a fixed location within the coal mine. Likewise, the shearer orientation may be understood as an angular deviation of the shearer relative to a physical, absolute coordinate system. More precisely, the shearer orientation may comprise a yaw, pitch, and roll angle.

In the sense of the present disclosure, a relative shearer coordinates may be a 1D coordinate running from a fixed location of another component of a longwall sheerer, or another moving part which is not spatiality fixed tool the coal mine.

In the sense of the present disclosure, retrieving sensor data may be achieved using an analog sensor device in combination with a data acquisition unit, using a digital sensor device or digital data alone. In addition, the calculation step of the present disclosure may comprise an output, outputting the 3D position and orientation of the longwall shearer.

By retrieving additional sensor data indicative of a relative shearer coordinate, a further sensor information may be provided and used such that it is provided as an additional value for consideration in the calculation. As an example, by calculating the 3D position and orientation of the longwall sheerer based on the absolute coordinate, the shearer orientation and the relative shearer coordinate, the calculation results are more refined in comparison to using only absolute shearer coordinate and shearer orientation, since the latter are subject to data drift, causing issues in the steering controls and restrict further developments.

According to an embodiment, the absolute shearer coordinate may comprise multiple encoder positions, wherein the additional sensor data indicate of a relative coordinate may comprise a retreat cylinder deflection in a face advance direction. By that, position estimation is possible in face advance direction. Further, an additional value for the yaw angle of the longwall shearer may be provided, by which your angle drift using only inertia measurement unit data can be avoided.

In other words, the algorithm may be designed such as to stabilize the yaw angle which helps to improve an estimate of the shearer position in the seam.

According to a further development of this embodiment, the calculation step may comprise, for a given encoder position, the steps of retrieving a previous height value of the previous floor profile, predicting a current predicted height value of the current floor profile, observing a current observed height value based on the retrieved height value, the retreat cylinder deflection, and a current shearer roll angle, and estimating a current estimated height value of the current floor profile by a combination of the current predicted height value and the current observed height value.

By that, the algorithm is suitable for considering roll angle deviations which might occur if coal accumulates between the coal face the longwall sheerer.

According to a further development of this embodiment, the method may further comprise the steps of determining current shearer shoe positions for a current encoder position based on current retreat cylinder deflections, and determining a current shearer yaw angle and the current shearer position in the moving direction. By that and by knowing the shearer geometry and shearer shoe geometry, a conclusion about the 3D position and orientation of the longwall shearer may be obtained. By this, the yaw angle ψ drift may be reduced substantially.

According to a further development of this embodiment, the calculation step may comprise an optimization algorithm, comprising a regression algorithm and/or a Kalman Filter. By that, an initial value can be combined with an additional measured value by a stepwise optimization process.

As an example, the common filter may comprise a prediction step followed by an observation step, wherein an initial value is predicted to yield a pre-estimate and subsequently, in the observation step a measurement update is added to achieve a post estimate, which may then be looped back to the prediction step.

According to a further development, the method may further comprise the step of interpolating relative coordinates. By that, additional relative coordinates may be obtained for positions where no physical measurement or retrieval of a relative coordinate is available.

According to a further development, the method may further comprise the step of generating a shearer trajectory from at least two different outputs of the calculation step. Thereby, a precise digital representation of the shearer trajectory may be achieved, which is crucial for analyzing the mining process, for comparing nominal an actual shearer positions and orientations, and for providing a digital twin of the longwall sheerer during operation in the coal mine.

According to a second embodiment of the present disclosure, the method may further comprise the steps of predicting a predicted panline, estimating an estimated panline, calculating an expected panline based on the predicted panline and the estimated panline.

By that, the 3D position of the longwall sheerer may be calculated based on panline geometry information in combination with sensor data taken from longwall sheerer and/or further components of the longwall sheerer system. This has the advantage, that a precise 3D position and orientation of the longwall sheerer during operation in the coal panel may be achieved, which is crucial for analyzing the mining process, for comparing nominal an actual shearer positions and orientations, and for providing a digital twin of the longwall sheerer during operation in the coal mine.

According to a further development of the second embodiment, the panline prediction step may comprise the steps of retrieving a current panline, retrieving retreat cylinder deflections from the additional sensor data, and retrieving a floor profile, wherein the panline prediction may further comprise the step of using physical equations suitable to calculate the position and orientation of each pan and/or the complete panline, wherein the physical equations may comprise gravity, relay bar forces, and/or pan collision forces.

By that the algorithm may be used to predict the pans' position and orientation on the floor. The panline pose in the seam may be determined based on the last pan profile, the retreat information in face advance direction, the knowledge about the floor and the pan geometry. Pans physically interact with each other. The movements may be restricted by dogbones, the floor and the displacement of the retreat cylinders in the roof supports. All these interactions may lead to physical equations which can be used to calculate the position and orientation of each pan and finally the complete panline.

According to a further development of the second embodiment, the panline estimation may be established using the sensor data indicative of an absolute shearer coordinate, a shearer orientation, and/or a shearer shoe position. By including such additional sensor data indicate of a relative shearer coordinate, a further sensor information may be provided and used such that it is provided as an additional value for consideration in the calculation.

According to a further development, the step of calculating an expected panline based on the predicted panline and the estimated panline may comprise the step of merging the panline estimation and the panline prediction into a final result using an optimization algorithm, preferably a Kalman Filter. In case other information sources are available, e. g. pan angles or roadway data to name only some common sources, this information might also be integrated into the Kalman filter.

Using a Kalman Filter allows an efficient recursive filter estimating the internal-state of a linear dynamic system from a series of noisy measurements.

A pan for a panline for use in a method according to the present disclosure may be provided.

According to a development of the panline, the panline may further comprise one or more sensor device configured to measure gravity, relay bar forces, and/or pan collision forces. Thereby, the panline prediction may be established in the prediction step.

A longwall shearer may be provided, comprising at least one pan according to the present disclosure, one or more hydraulic roof supports, the longwall shearer being configured for use in the method according to present disclosure, wherein the longwall shearer comprises a sensor device configured to retrieve sensor data indicative of an absolute shearer coordinate and a shearer orientation and configured to retrieve additional sensor data indicative of a relative shearer coordinate.

To this end, the sensor device may comprise or consist of one, two, or more dedicated sensor devices, comprising, but not limited to, an Inertial Navigation System, an encoder or odometer, and a hydraulic cylinder deflection measuring device.

### INDUSTRIAL APPLICABILITY

With reference to the Figures, a method for determining a 3D position of a longwall shearer, a pan of a panline, and a long wall shearer system are applicable in any longwall shearer application.

In practice, a method for determining a 3D position of a longwall shearer, a pan of a panline, and a long wall shearer system may be implemented, manufactured, bought, or sold to retrofit a longwall mining shearer already deployed in the field in an aftermarket context, or alternatively may be implemented, manufactured, bought, sold or otherwise obtained in an OEM (original equipment manufacturer) context.

As alluded to previously herein, the aforementioned embodiments may increase the reliability and performance of a 3D shearer positioning as will be elaborated further herein momentarily.

The present description is for illustrative purposes only and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items and may be used interchangeably with “one or more.” Where only one item is intended, the term “one” or similar language is used. Also, as used herein, the terms “has,” “have,” “having,” “include”, “includes”, “including”, or the like are intended to be open-ended terms. Further, the phrase “based on” is intended to mean “based, at least in part, on” unless explicitly stated otherwise. Further, coordinate axes are intended to be exemplary only without delimiting the scope of the disclosure.

All references to the disclosure or examples thereof are intended to reference the example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of values or dimensions herein are merely intended to serve as a shorthand method of referring individually to each separate value falling within the range, unless otherwise indicated herein, and each separate value is incorporated into the specification as if it were individually recited herein.

Furthermore, variations or modifications to certain aspects or features of various embodiments may be made to create further embodiments and features and aspects of various embodiments may be added to or substituted for other features or aspects of other embodiments to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A method for determining a 3D position of a longwall shearer traveling on a panline along a longwall face of an underground coal mining panel, the method comprising the steps of
retrieving sensor data indicative of an absolute shearer coordinate and a shearer orientation;
retrieving additional sensor data indicative of a relative shearer coordinate; and
calculating the 3D position and orientation of the longwall shearer based on the absolute coordinate, the shearer orientation, and the relative shearer coordinate.

2. The method according to claim 1, wherein the absolute shearer coordinate (x) comprises multiple encoder positions, and wherein the additional sensor data indicative of a relative coordinate comprises a retreat cylinder deflection in a face advance direction.

3. The method according to claim 2, wherein the calculation step (S30) comprises, for a given encoder position, the steps of
retrieving a previous height value of a previous floor profile,
predicting a current predicted height value of a current floor profile (n),
observing a current observed height value based on the retrieved height value, the retreat cylinder deflection and a current shearer roll angle, and
estimating a current estimated height value of the current floor profile by a combination of the current predicted height value and the current observed height value.

4. The method according to claim 2, further comprising the steps of
determining current shearer shoe positions for a current encoder position based on current retreat cylinder deflections; and
determining a current shearer yaw angle and the current shearer position in the moving direction.

5. The method according to claim 2, wherein the calculation step comprises an optimization algorithm, comprising a regression algorithm and/or a Kalman Filter.

6. The method according to claim 2, further comprising the step of interpolating relative coordinates.

7. The method according to claim 2, further comprising the step of generating a shearer trajectory from at least two different outputs of the calculation step.

8. The method according to claim 2, further comprising the steps of
predicting a predicted panline;
estimating an estimated panline;
calculating an expected panline based on the predicted panline and the estimated panline.

9. The method according to claim 8, wherein the panline prediction ( ) comprises the steps of
retrieving a current panline,
retrieving retreat cylinder deflections from the additional sensor data, and
retrieving a floor profile, wherein the panline prediction further comprises the step of
using physical equations suitable to calculate the position and orientation of each pan and/or the complete panline, wherein the physical equations comprise gravity, relay bar forces, and/or pan collision forces.

10. The method according to claim 9, wherein the physical equations may be resolved by an optimization algorithm, preferably comprising a Newton method.

11. The method according to claim 8, wherein the panline estimation is established using the sensor data indicative of an absolute shearer coordinate, a shearer orientation, and/or a shearer shoe position.

12. The method according to claim 8, wherein the step of calculating an expected panline based on the predicted panline and the estimated panline comprises the step of merging the panline estimation and the panline prediction ( ) into a final result using an optimization algorithm, preferably a Kalman Filter.

13. Pan for a panline for use in a method according to claim 1.

14. Pan according to claim 13, comprising one or more sensor device configured to measure gravity, relay bar forces, and/or pan collision forces.

15. Longwall shearer system comprising a longwall shearer, at least one pan according to any of the claim 13, one or more hydraulic roof suppo, the longwall shearer being configured for use in the method according to claim 1, wherein the longwall shearer comprises a sensor device configured to retrieve sensor data indicative of an absolute shearer coordinate and a shearer orientation and configured to retrieve additional sensor data indicative of a relative shearer coordinate.
